(19) United States
(12) Patent Application Publication
(10) Pub. No.: US 2008/0037529 A1
(43) Pub. Date: Feb. 14, 2008

(54) MESSAGE DELIVERY AND PLAYBACK

(75) Inventors: Raghuveer Bangalore, San Jose, CA (US); Vamsi K. Pottangi, Visakhapatnam (IN); Ilankumaran Neelamegam, Bangalore (IN); Vikram Meghal, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies, Ltd., Bangalore (IN)

(21) Appl. No.: 11/836,648

(22) Filed: Aug. 9, 2007

(30) Foreign Application Priority Data
Aug. 9, 2006 (IN) 1426/CHE/2006

(51) Int. Cl. H04L 12/66

(52) U.S. Cl. 370/354

(57) ABSTRACT

Messages can be delivered to end-user communication devices for playback to users of the end-user communication devices during call progress events by selecting messages to deliver and delivering the selected messages to the end-user communication device, where the end-user communication device stores the messages and plays back the stored messages during call progress events of subsequent calls. A system for delivering messages to end-user communication devices can comprise a message delivery module configured to deliver messages prior to calls where the messages are played and a reception module configured to receive indications of interest in the messages. An end-user communication device for playing back messages during call progress events can comprise a communication module configured to receive messages when not engaged in a call, a storage module configured to store messages, and a playback module configured to play back stored messages during later calls.

### BACKGROUND

With the increasing popularity of communication devices, such as mobile phones and Internet phones, there is a growing need for providing messaging services, such as advertising messaging services, to users of such communication devices. Existing technologies allow a phone switch to play messages during a phone call. For example, a phone switch can play a recorded message, such as an advertising message, in place of a ring-back tone. However, requiring the switch to play back the messages can require significant computing resources, especially during peak usage times.

Internet Protocol (IP) telephony, such as Voice over Internet Protocol (VoIP), is a growing area of communications. Advertising over the Internet has traditionally involved displaying images on web pages, such as banner advertisements. However, such an advertisement model may not be applicable to VoIP communications.

Therefore, there exists ample opportunity for improvement in technologies related to message delivery and playback in a communication network.

### SUMMARY

A variety of technologies related to message delivery and playback in a communication network can be applied. For example, messages can be delivered to end-user communication devices for playback to users of the end-user communication devices during call progress events by selecting one or more messages to deliver to an end-user communication device and delivering the one or more messages to the end-user communication device, where the end-user communication device stores the messages and plays back the stored messages during call progress events of subsequent calls. The messages to be delivered can be selected based on various criteria, such as user profile information or indications of user interest to prior messages. Information can be received form the end-user communication device. For example, the received information can comprise an indication of which messages have been played back. The information can also comprise an indication that the user has indicated interest in a message during or after playback.

A system can deliver messages to end-user communication devices for playback to users during call progress events. For example, the system can comprise a message delivery module configured to deliver messages to end-user communication devices prior to calls where the messages are played and a reception module configured to receive information comprising indications that the users of the end-user communication devices have indicated interest in the played-back messages.

An end-user communication device can play back messages to users during call progress events. For example, the end-user communication device can comprise a communication module configured to receive messages (e.g., from a communication network) when not engaged in a call, a storage module configured to store the received messages, and a playback module configured to play back the stored messages to a user of the end-user communication device during call progress events, where the messages are played back during calls initiated after the messages are received and stored by the end-user communication device.

The foregoing and other features and advantages will become more apparent from the following detailed description, which proceeds with reference to the accompanying figures.

### BRIEF DESCRIPTION OF THE DRAWINGS

FIG. 1 is a diagram showing an exemplary system for delivering messages to end-user communication devices.

FIG. 2 is a flowchart showing an exemplary method for delivering messages to end-user communication devices.

FIG. 3 is a diagram showing an exemplary VoIP system for delivering messages to end-user communication devices.

FIG. 4 is a diagram showing an exemplary phone system for delivering messages to end-user communication devices.

FIG. 5 is a flowchart showing an exemplary method for delivering messages to end-user communication devices and receiving information.

FIG. 6 is a diagram showing an exemplary system for automatically connecting users to providers of messages.

FIG. 7 is a diagram showing an exemplary system comprising a communication system and end-user communication devices.

FIG. 8 is a block diagram illustrating an example of a computing environment that can be used to implement any of the technologies described herein.

### DETAILED DESCRIPTION OF EXEMPLARY EMBODIMENTS

### Example 1

### Exemplary Messages

In any of the examples herein, messages refer to information delivered to users by end-user communication devices. For example, a message can be an advertising message (e.g., a message advertising the products and/or services of a business or organization). A message can also be an announcement, alert, notification, or another type of non-advertising message.

Messages can be of a variety of types or formats. For example, messages can be text messages (e.g., static or scrolling text messages), audio messages (e.g., comprising spoken words and/or music), video messages, or a combination.

Messages can be organized by category. For example, advertising messages relating to insurance products or services can be arranged in categories such as: automobile insurance, homeowners insurance, life insurance, and the like.

### Example 2

### Exemplary End-User Communication Device

In any of the examples herein, an end-user communication device can be a communication device used for placing calls and playing back messages. For example, an end-user communication device can be a phone, such as a cell phone, mobile phone, smart phone, PDA phone, or the like. The end-user communication device can also be a Voice over Internet Protocol (VoIP) device. For example, the end-user communication device can be a computing device, such as a desktop computer, laptop computer, tablet computer, or PDA, with software enabling the computing device to make VoIP calls over the Internet.

In a specific implementation, the end-user communication devices include Internet Protocol (IP) connectivity for receiving messages and sending information (e.g., an IP-enabled end-user communication device). For example, IP connectivity can be provided over an IP computing network (e.g., the Internet) or over other types of communication networks (e.g., GSM or CDMA cellular networks) that include IP communication capability. A communication network that supports IP communication (e.g., the Internet or other types of communication networks that include IP communication capability) can be known as an IP communication network.

An end-user communication device can be a device configured to make calls (e.g., audio and/or video calls) over a communication network. An end-user communication device, such as cell phone or mobile phone, can be used to make calls over a phone network, such as the public switched telephone network (PSTN). An end-user communication device, such as a VoIP device, can be configured to make calls over a computing network, such as the Internet.

The end-user communication device can be capable of playing back messages. For example, the end-user communication device can be capable of playing (e.g., displaying) text messages, playing audio messages, and/or playing video messages.

Messages can be played back to a user of the end-user communication device.

### Example 3

### Exemplary Profile

In any of the examples herein, a profile can store information related to a user of an end-user communication device. For example, a user can sign up for a communication service (e.g., mobile phone service or VoIP service). Upon signing up, or at a later time, the user can enter profile information (e.g., stored by the communication service provider). Profile information can comprise contact information (e.g., name, phone number, address, email address, etc.), specific categories of messages (e.g., advertising messages) that are of interest to the user (e.g., banking services, financial services, travel, music, sports, etc.), billing information, service preferences, and other types of profile information.

Profile information can also be entered or edited by a communication service provider. For example, the communication service provider can receive indications of user interest in messages. The interest can be recorded in the user's profile (e.g., that the user has indicated interest in specific messages or specific categories of messages). The service provider can also record information regarding messages that have been delivered and/or played back to the user

Profile information can include service preferences. For example, service can be discounted if a user is willing to listen to and/or view advertising messages. In a specific implementation, the user can set service preferences enabling advertising messages (if enabled the user will receive the discounted rate, and if disabled the user will not receive the discounted rate) and setting the frequency of advertising messages (e.g., a maximum number of messages per call or per day).

### Example 4

### Exemplary Delivering Messages

In any of the examples herein, messages can be delivered to end-user communication devices. For example, messages can be delivered to end-user communication devices by systems (e.g., phone systems) by message delivery modules (e.g., software and/or hardware modules of phone switches or servers). Messages can be delivered to end-user communication devices by computing networks (e.g., by software and/or hardware modules of VoIP systems or servers).

Messages can be delivered at various times. For example, messages can be delivered when end-user communication devices are not engaged in a call (e.g., a phone call). Even when not engaged in a call, end-user communication devices can be connected to a network or system so that messages can be delivered. Message delivery can be limited to times when end-user communication devices are not engaged in a call so as to not interfere calling activity.

Messages can be delivered when end-user communication devices are idle. For example, messages can be delivered when an end-user communication device is powered-on, but not currently engaged in any activity (e.g., user activity), such as calling, typing messages, browsing the Internet, listening to music, or other activities. Limiting delivering of messages to times when end-user communication devices are idle can reduce or eliminate the possibility of message delivery interfering with other activity being performed by the end-user communication devices.

Messages can be delivered to end-user communication devices when end-user communication devices are engaged in a call or other activity. For example, the messages can be delivered in the background (e.g., using excess bandwidth). For example, a message delivery module of a server or switch can push messages to end-user communication devices during calls or other activity (e.g., in the background). Messages can be delivered during periods of no, or limited, network activity (e.g., when a user is using the device for a function that does not require network bandwidth, such as using a calculator function).

Message delivery can be based on end-user communication device capability. For example, when an end-user communication device connects to a communication network, the capability of the end-user communication device (e.g., processing speed, memory, supported message types, etc.) can be communicated (e.g., to a switch, server, or VoIP device). Based on the capability, message delivery can be tailored (e.g., if the end-user communication device only supports text and audio messages, then message delivery can be limited to text and audio messages).

Messages can be selected for delivery (e.g., by a message delivery module) based on various criteria. For example, messages can be selected based on a profile (e.g., a user profile comprising preferred message categories or indications of past user interest). For example, if a user indicates interest in a specific category, then messages can be selected from the same category for a period of time (e.g., a number of days). If the user does not indicate interest in any of the messages of the specific category for the period of time, message selection criteria can change (e.g., revert to a default algorithm, such as random selection).

Messages (e.g., advertising messages) can also be selected based on other criteria, such as a ranking of messages, a ranking of categories of messages, message popularity, paid placement, time and/or date, location (e.g., geographic location of end-user communication devices), etc.

### Example 5

### Exemplary Receiving and Storing Messages

In any of the examples herein, messages can be received and/or stored by end-user communication devices. For example, messages can be received by end-user communication devices from communication networks (e.g., from phone systems or from the Internet). Messages can be stored by end-user communication devices after they are received. For example, messages can be stored in memory (e.g., RAM, flash memory, storage media, or the like).

Messages and be received and stored before the messages are played back. For example, messages can be received and stored for playback during subsequent calls.

One or more messages can be received and stored at the same time. For example, multiple messages can be received and stored during a time when an end-user communication device is idle.

Messages can be assigned unique identifiers (e.g., in order to track message playback and indications of user interest).

### Example 6

### Exemplary Playing Back Messages

In any of the examples herein, messages can be played back by end-user communication devices. For example, the messages can be played back to users of the end-user communication devices. How messages are played back can depend on message type. For example, playing back text messages can comprise displaying the text messages (e.g., static or as scrolling text) on a display of the end-user communication device. Playing back audio messages can comprise playing the audio messages via a speaker (e.g., built-in speaker, wireless speaker, etc.) of the end-user communication device. Playing back video messages can comprise displaying video (e.g., on a display) and/or playing audio (e.g., via a speaker).

Messages can be played back at various times. For example, messages can be played back during call progress events occurring during calls.

### Example 7

### Exemplary Call Progress Events

In any of the examples herein, call progress events can be events that occur during a call (e.g., a phone or VoIP call). For example, call progress events can be events such as status or error events that occur during a call, such as dial tone events, ring tone events, busy tone events, ring-back tone events, hold events, call transfer or forward events, or other call progress events.

Messages can be played back during call progress events. For example, an end-user communication device can make a call (e.g., a user of the end-user communication device can initiate a call to a user of another end-user communication device). If the party being called is not available (e.g., already on a call), then a busy tone can be played. Instead of (e.g., in place of) the busy tone (the typical busy tone event notification), a message can be played instead (e.g., an advertising message).

A message can also be played along with a typical call progress event notification. For example, a short busy tone or other busy notification can precede playback of a message. In this way, a user can be notified of the status of the call (e.g., that the party being called is busy) and then the message can be played back (e.g., an advertising message can be played back after the user is notified that the other party is busy).

Playback of messages by end-user communication devices can be controlled by a server or switch of a communication network. For example, a server or switch can override a message scheduled to be played back by an end-user communication device, instruct an end-user communication device to play a different message, or play back a message itself. For example, consider an end-user communication device that has received, stored, and scheduled a message for playback during a call progress event of a subsequent call. When setting up the subsequent call, the end-user communication device can receive an instruction (e.g., receive an instruction from a VoIP server handling a VoIP call) overriding the scheduled message (e.g., instructing the end-user communication device to not play any message or to play a different message from its memory of previously stored messages).

### Example 8

### Exemplary Indication of Interest

In any of the examples herein, users of end-user communication devices can express interest in messages being played. Indications of interest can be expressed in a variety of ways. For example, during playback of a message (e.g., an advertising message), a user can express interest in the advertising message by pressing a key or speaking a phrase. A user can also express interest at a later time (e.g., after the message has finished playing). For example, a user can later select a previously played message from a directory or list of played messages (e.g., displayed by the end-user communication device).

Expressing interest in a message can trigger an event. For example, expressing interest in an advertising message can result in a connection being established between the user who has expressed interest and a provider (e.g., a business or merchant) of the advertising message. For example, if the user is calling a friend using an end-user communication device (e.g., the user's mobile phone or VoIP phone), the end-user communication device can play back an advertising message for auto insurance in place of a ring tone. If the user indicates interest in the auto insurance advertising message (e.g., by pressing a key or speaking a phrase), the end-user communication device can communicate the indication of interest to the communication network (e.g., to a phone switch or VoIP server). After the user's call is over, the communication network (e.g., the phone switch or VoIP server) can establish a connection (e.g., a phone call) between the user and the provider (e.g., the insurance company) of the auto insurance advertising message (e.g., the communication network can automatically connect a representative of the insurance company with the user).

An automatic call-back can also be performed by the provider of the message. For example, the message provider can automatically receive contact information when a user has indicated interest in one of the advertiser's messages. For example, the contact information can comprise a name and phone number of the user indicating interest as well as an indication of the message the user is interested in (e.g., a specific message identifier or a specific product or service, such a specific insurance product). The contact information can also include other information, such as credit information, billing information, email contact information, etc. The contact information can be provided automatically by the communication network (e.g., phone switch, server, VoIP server, etc.) to the message provider. The message provider can then contact the user.

A user who is interested in a message (e.g., an advertising message) can indicate interest in other ways. For example, the user can contact (e.g., call) the message provider using contact information provided during the message or obtained form another source (e.g., a web site).

### Example 9

### Exemplary Receipt of Information

In any of the examples herein, information regarding messages can be received from end-user communication devices. Information can be received based on message playback and/or indications of user interest. For example, an end-user communication device can receive and store messages. During subsequent calls, the end-user communication device can play back some or all of the stored messages. Information regarding which messages were played back by the end-user communication device can be received (e.g., by a reception module of a switch or server in a communication system) from the end-user communication device.

In addition to, or instead of, tracking which messages were played, the end-user communication device can track (e.g., record) indications of user interest. For example, if a user indicates interest in a specific advertising message being played (e.g., by pressing a key or speaking a phrase), the end-user communication device can record information comprising the indication of interest (e.g., the unique message identifier). The indication of interest can then be received from the end-user communication device (e.g., the end-user communication device can deliver or provide the indication of interest to a switch or server).

### Example 10

### Exemplary System for Delivering Messages to End-User Communication Devices

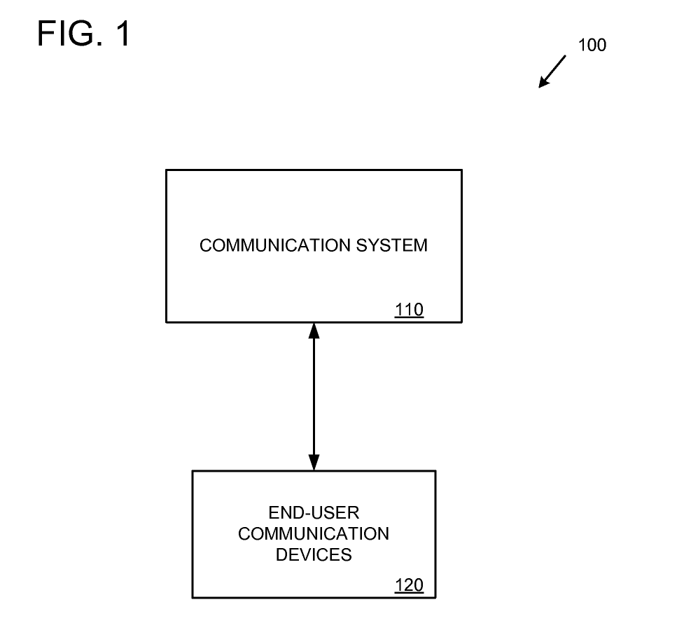

FIG. 1 shows an exemplary system 100 for delivering messages to end-user communication devices. For example, the system can be the public switched telephone network, a computer network such as the Internet, a cellular or wireless network, or a combination.

In the example system 100, a communication system 110 provides communication services to end-user communication devices 120. For example, the communication system 110 can comprise various communication services, components, and/or devices, such as phone switches, VoIP servers, IP telephony servers, cellular or mobile switches, routers, gateways, etc. For example, communication system 110 can provide IP communication capability.

In the example system 100, the communication system 110 delivers messages (e.g., advertising messages) to the end-user communication devices 120. For example, the messages can be delivered over a phone network (e.g., via the public switched telephone network) or a computing network (e.g., via the Internet). In a specific implementation, the communication system 110 delivers messages via an IP communication network (e.g., the Internet, or via another type of communication network that supports IP communication capability) to IP-enabled end-user communication devices.

The end-user communication devices 120 can receive and store the messages from the communication system 110. For example, the end-user communication devices can comprise mobile phone devices (e.g., mobile or cellular phones) or VoIP devices (e.g., computing devices with VoIP capability). The end-user communication devices 120 can play back the messages during call progress events of subsequent calls. In a specific implementation, the end-user communication devices 120 are IP-enabled end-user communication devices.

### Example 11

### Exemplary Method for Delivering Messages to End-User Communication Devices

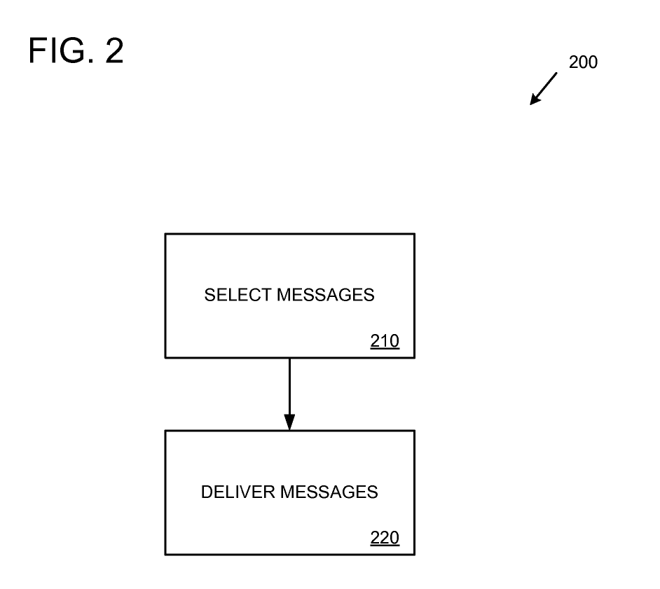

FIG. 2 shows an exemplary method 200 for delivering messages to end-user communication devices. At 210, one or more messages are selected for delivery to an end-user communication device. For example, the messages can be selected for delivery based on a profile created by a user of the end-user communication device (e.g., a profile indicating message categories of interest to the user) or based on past indications of interest by the user.

At 220, the selected messages are delivered to the end-user communication device. The messages can be stored by the end-user communication device. The end-user communication device can play back the stored messages during call progress events of subsequent calls. The messages can be delivered when the end-user communication device is not engaged in a call (e.g., when the end-user communication device is idle).

### Example 12

### Exemplary VoIP System for Delivering Messages to End-User Communication Devices

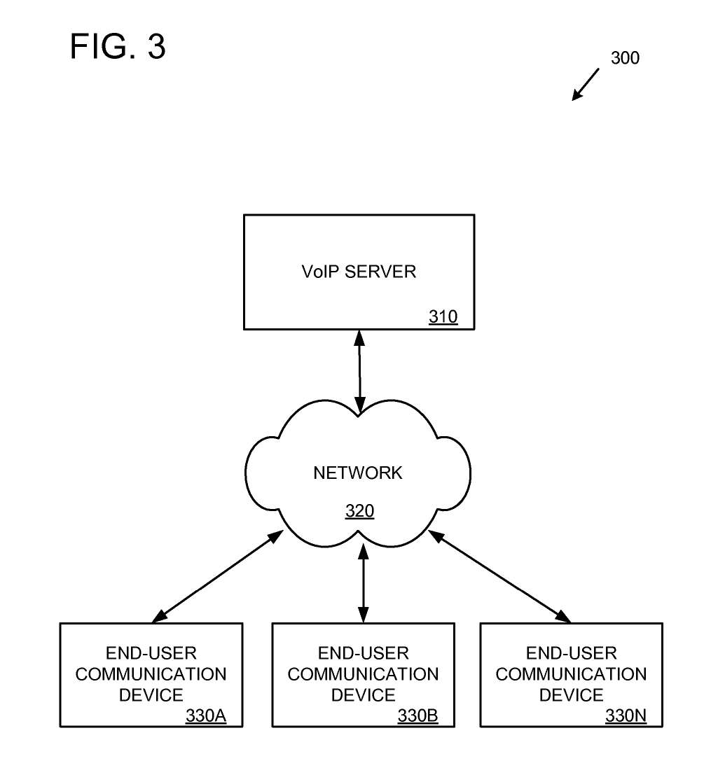

FIG. 3 shows an exemplary VoIP system 300 for delivering messages to end-user communication devices. The example VoIP system 300 includes a VoIP server 310. For example, the VoIP server 310 can be a computer server running VoIP software. The VoIP server 310 provides messaging functionality, such as delivery of messages, storage of user profiles, and receipt of information.

The VoIP server 310 is connected to end-user communication devices 330A-N via a network 320 (e.g., the Internet). For example, the end-user communication devices, 330A-N, can be computing devices (e.g., computers such as laptop or desktop computers, mobile VoIP phone devices, or other types of computing devices) running VoIP software. For example, an end-user communication device (e.g., 330A, 330B, or 330N) can be a wired VoIP phone.

In the example VoIP system 300, the VoIP server 310 delivers messages (e.g., advertising messages) to end-user communication devices 330A-N. The server 310 delivers the messages over the network 320 when the end-user communication devices 330A-N are connected to the network 320. The server 310 can deliver the messages when the end-user communication devices 330A-N are not engaged in calls.

The end-user communication devices 330A-N can receive and store the messages received form the VoIP server 310. The messages can be received and stored for playback during subsequent calls (e.g., calls to be placed or received after the messages have been downloaded and stored).

The end-user communication devices 330A-N can communicate information back to the VoIP server 310. For example, the information communicated back to the server 310 can comprise indications of which messages have been played back by the end-user communication devices 330A-N and/or indications of messages for which users of the end-user communication devices 330A-N have indicated interest. The information communicated back to the server 310 can be used, for example, during selection of additional messages to be delivered.

For example, the VoIP server 310 can deliver messages to the end-user communication device 330A when the end-user communication device 330A is not engaged in a call (e.g., when it is idle but still connected to the network 320). The end-user communication device 330A can store the received messages. Later, the end-user communication device 330A can call another end-user communication device (e.g., 330B). During a call progress event (e.g., a busy event, ring event, or ring-back event), the end-user communication device 330A can play back one or more of the stored messages (e.g., in place of the typical call progress event indication) to a user of the end-user communication device 330A. If the user indicates interest in one of the messages, the end-user communication device 330A can communicate that information to the server 310. The end-user communication device 330A can also communicate other information to the server 310, such as which messages were played back to the user. Based on the information received by the server 310, additional messages (e.g., messages targeted to the user's interests) can be delivered to the end-user communication device 330A.

### Example 13

### Exemplary Phone System for Delivering Messages to End-User Communication Devices

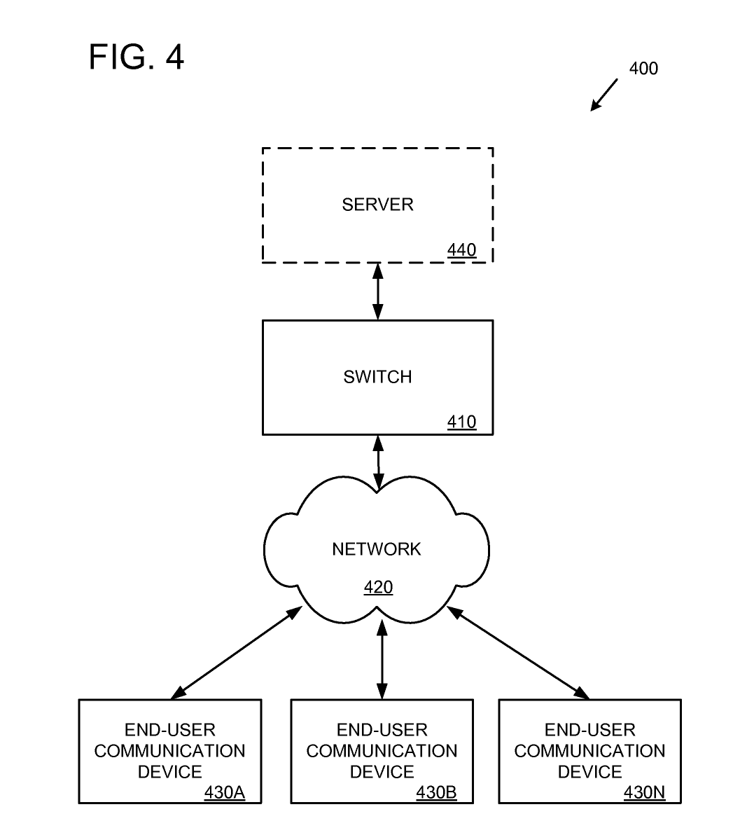

FIG. 4 shows an exemplary phone system 400 for delivering messages to end-user communication devices. For example, the phone system 400 can be the public switched telephone network.

The phone system 400 includes a switch 410 (e.g., a phone switch). In a specific implementation, the switch 410 provides messaging functionality, such as delivery of messages, storage of user profiles, and receipt of information. For example, the switch 410 can include various modules (e.g., modules implemented by hardware, software, or a combination). The modules can include a message delivery module and a reception module. The modules can also include a storage module. Alternatively, a server 440 (e.g., a separate computer server connected to the switch 410) can provide some or all of the module functionality (e.g., message delivery, reception, and/or storage).

The switch 410 is connected, via a network 420, to end-user communication devices 430A-N. The network can comprise land lines, wireless connections, other switches or gateways, or other communications facilities.

The end-user communication devices, 430A-N, can be mobile phones, smart phones, PDA phones, or other types of communication devices capable of communicating with the phone system 400 via the network 420.

In the example phone system 400, the switch 410 (or, in some implementations, the server 440) delivers messages (e.g., advertising messages) to end-user communication devices 430A-N via the network 420. The switch 410 can deliver the messages when the end-user communication devices 430A-N are connected to the network 420. The switch 410 can deliver the messages when the end-user communication devices 430A-N are not engaged in calls (e.g., when connected to the network 420, but otherwise idle).

The end-user communication devices 430A-N can receive and store the messages received from the switch 410 (or server 440). The messages can be received and stored for playback during subsequent calls (e.g., calls to be placed or received after the messages have been downloaded and stored).

The end-user communication devices 430A-N can communicate information back to the switch 410 (or server 440) via the network 420. For example, the information communicated back to the switch 410 can comprise indications of which messages have been played back by the end-user communication devices 430A-N and/or indications of messages for which users of the end-user communication devices 430A-N have indicated interest. The information communicated back to the switch 410 can be used, for example, during selection of additional messages to be delivered.

For example, the switch 410 (or server 440) can deliver messages to the end-user communication device 430A when the end-user communication device 430A is not engaged in a call (e.g., when it is idle but still connected to the network 420). The end-user communication device 430A can store the received messages. Later, the end-user communication device 430A can call another end-user communication device (e.g., 430B). During a call progress event (e.g., a busy event, ring event, or ring-back event), the end-user communication device 430A can play back one or more of the stored messages (e.g., in place of the typical call progress event indication) to a user of the end-user communication device 430A. If the user indicates interest in one of the messages, the end-user communication device 430A can communicate that information to the switch 410 (or to the server 440). The end-user communication device 430A can also communicate other information to the switch 410, such as which messages were played back to the user. Based on the information received by the switch 410, additional messages (e.g., messages targeted to the user's interests) can be delivered to the end-user communication device 430A.

### Example 14

### Exemplary Method for Delivering Messages to End-User Communication Devices and Receiving Information

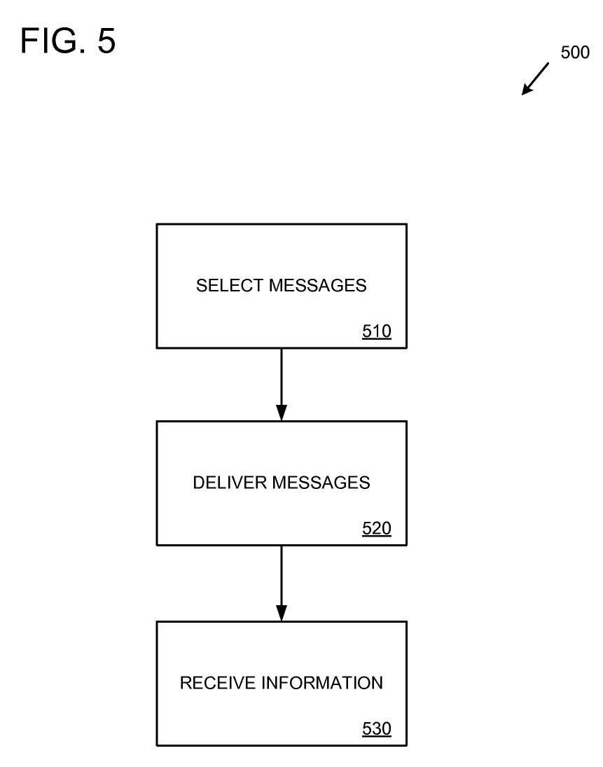

FIG. 5 shows an exemplary method 500 for delivering messages to end-user communication devices and receiving information from end-user communication devices. At 510, one or more messages are selected for delivery to an end-user communication device. For example, the messages can be selected for delivery based on a profile created by a user of the end-user communication device (e.g., a profile indicating message categories of interest to the user) or based on past indications of interest by the user.

At 520, the selected messages are delivered to the end-user communication device. For example, the messages can be stored by the end-user communication device. The end-user communication device can play back the stored messages during call progress events of subsequent calls. The messages can be delivered when the end-user communication device is not engaged in a call (e.g., when the end-user communication device is idle).

At 530, information is received from the end-user communication device. For example, the information received can comprise an indication of which stored messages have been played back by the end-user communication device during the subsequent calls. The information can also comprise an indication that the user has indicated interest in one or more of the messages (e.g., during playback of the messages).

### Example 15

### Exemplary System for Automatically Connecting Users and Providers of Messages

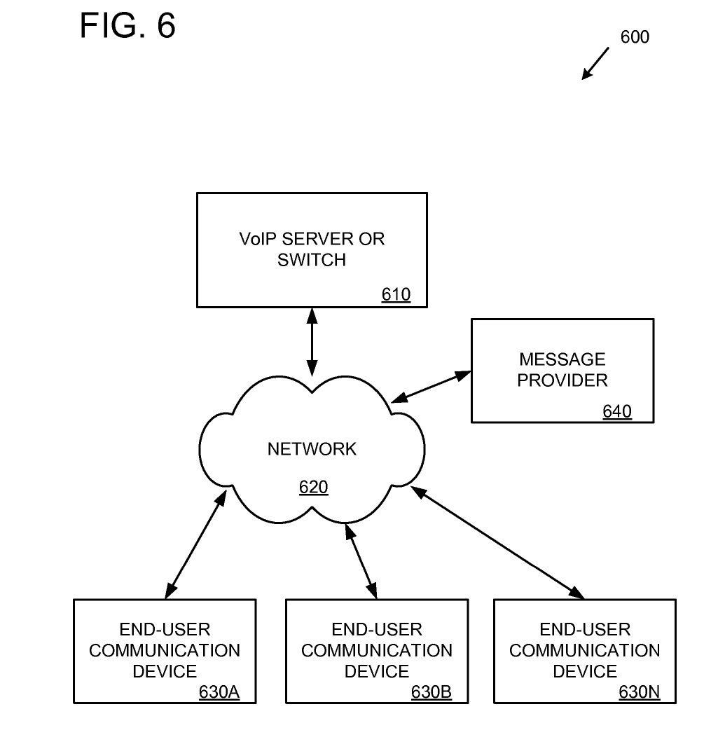

FIG. 6 shows an exemplary system 600 (a VoIP system or a phone system) for delivering messages and automatically connecting users and providers of the messages.

The system 600 includes a VoIP server or switch 610 for delivering messages to end-user communication devices, storing information such as user profiles, and receiving information from end-user communication devices. The VoIP server or switch 610 is connected, via a network 620, to end-user communication devices 630A-N. For example, the network 620 can be the public switched telephone network or the Internet. The network 620 can comprise land lines, wireless connections, switches or gateways, computer networks, or other communications facilities.

The example system 600 includes a message provider 640. The message provider is a provider of messages delivered to the end-user communication devices 630A-N. The message provider 640 can be a business or organization sponsoring or paying for the messages (e.g., advertising messages) to be delivered and played. For example, the message provider 640 can have a business relationship with a communication service provider providing service to the end-user communication devices 630A-N via the VoIP server or switch 610. In a specific implementation, the service costs paid by the users of the end-user communication devices 630A-N are subsidized by the message provider 640 (e.g., the users pay a reduced fee or no fee in exchange for listening or viewing advertising messages).

The example system 600 can be used to automatically connect users and providers of messages. For example, an advertising message can be delivered from the VoIP server or switch 610 to the end-user communication device 630A while the end-user communication device 630A not engaged in a call (e.g., when it is idle but still connected to the network 620). The end-user communication device 630A can store the received message. Later, the end-user communication device 630A can call another end-user communication device (e.g., 630B). During a call progress event (e.g., a busy event, ring event, or ring-back event), the end-user communication device 630A can play back the stored message (e.g., in place of the typical call progress event notification) to a user of the end-user communication device 630A. If the user indicates interest in the message, the end-user communication device 630A can communicate that information to the VoIP server or switch 610. The VoIP server or switch 610, upon receiving the information comprising the indication of interest in the advertising message, can automatically connect the user of the end-user communication device 630A with the provider 640 of the advertising message. For example, the connection can be automatically established when the user has finished the current call to the other end-user communication device 630B. The connection can also be automatically established by communicating contact information for the user (e.g., name and phone number) from the VoIP server or switch 610 to the message provider 640, and in response the message provider 640 can initiate contact (e.g., a call) with the user (e.g., immediately or at a later time). For example, the message provider 640 can be notified that the user has finished the call (e.g., automatically notified by the VoIP server or switch 610).

### Example 16

### Exemplary System

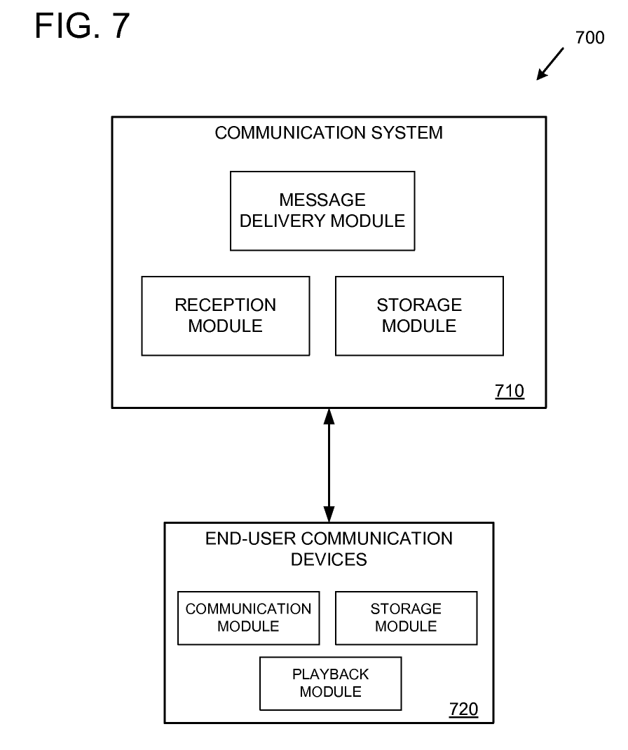

FIG. 7 shows an exemplary system 700 for delivering messages to end-user communication devices. In the example system 700, a communication system 710 provides various messaging services to end-user communication devices 720. For example, the communication system 710 can comprise switches, servers, VoIP servers, or other communication devices. The communication system 710 includes various modules (e.g., modules implemented in hardware, software, or a combination) for providing messaging services to the end-user communication devices 720.

The communication system 710 includes a message delivery module for delivering messages to the end-user communication devices 720. The message delivery module can be configured to deliver messages to the end-user communication devices 720 when the end-user communication devices 720 are not engaged in calls. The message delivery module can be configured to deliver messages to the end-user communication devices 720 prior to calls where the messages are played back by the end-user communication devices 720.

The communication system 710 includes a storage module for storing information such as user profile information. For example, the message delivery module can use the stored user profile information when selecting messages for delivery to the end-user communication devices 720.

The communication system 710 also includes a reception module for receiving information from the end-user communication devices 720. For example, the received information can comprise indications that the users of the end-user communication devices 720 have indicated interest in messages played back by the end-user communication devices 720.

The end-user communication devices 720 also include various modules. The end-user communication devices 720 include a communication module for receiving messages from the communication system 710 (e.g., for receiving messages from the message delivery module of the communication system 710). For example, the messages can be received by the communication module when the end-user communication devices 720 are not engaged in calls (e.g., when they are idle). The communication module can also be configured to send information to the communication system 710 (e.g., to the reception module of the communication system 710). For example, the information can comprise indications of messages that have been played back, or indications of messages for which user interest has been indicated.

The end-user communication devices 720 include a storage module for storing messages received from the communication system 710. Messages can be received by the communication module and stored in the storage module prior to calls by the end-user communication devices 720 during which the stored messages are to be played (e.g., played during call progress events of the calls).

The end-user communication devices 720 also include a playback module for playing back stored messages to users of the end-user communication devices 720 during call progress events.

In some implementations, some modules may or may not be present, module functionality may be combined, or module functionality may be performed by other components (e.g., by hardware and/or software not depicted in the example system 700).

### Example 17

### Exemplary Computing Environment

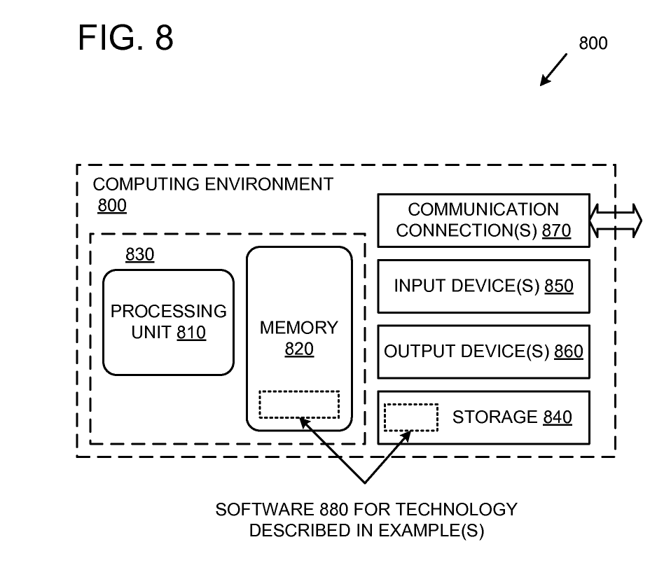

FIG. 8 illustrates a generalized example of a suitable computing environment 800 in which described embodiments, techniques, and technologies may be implemented. The computing environment 800 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 8, the computing environment 800 includes at least one central processing unit 810 and memory 820. In FIG. 8, this most basic configuration 830 is included within a dashed line. The central processing unit 810 executes computer-executable instructions and may be a real or a virtual processor. In a multi-processing system, multiple processing units execute computer-executable instructions to increase processing power and as such, multiple processors can be running simultaneously. The memory 820 may be volatile memory (e.g., registers, cache, RAM), non-volatile memory (e.g., ROM, EEPROM, flash memory, etc.), or some combination of the two. The memory 820 stores software 880 that can, for example, implement the technologies described herein. A computing environment may have additional features. For example, the computing environment 800 includes storage 840, one or more input devices 850, one or more output devices 860, and one or more communication connections 870. An interconnection mechanism (not shown) such as a bus, a controller, or a network, interconnects the components of the computing environment 800. Typically, operating system software (not shown) provides an operating environment for other software executing in the computing environment 800, and coordinates activities of the components of the computing environment 800.

The storage 840 may be removable or non-removable, and includes magnetic disks, magnetic tapes or cassettes, CD-ROMs, CD-RWs, DVDs, or any other medium which can be used to store information and which can be accessed within the computing environment 800. The storage 840 stores instructions for the software 880, which can implement technologies described herein.

The input device(s) 850 may be a touch input device, such as a keyboard, keypad, mouse, pen, or trackball, a voice input device, a scanning device, or another device, that provides input to the computing environment 800. For audio, the input device(s) 850 may be a sound card or similar device that accepts audio input in analog or digital form, or a CD-ROM reader that provides audio samples to the computing environment 800. The output device(s) 860 may be a display, printer, speaker, CD-writer, or another device that provides output from the computing environment 800.

The communication connection(s) 870 enable communication over a communication medium (e.g., a connecting network) to another computing entity. The communication medium conveys information such as computer-executable instructions, compressed graphics information, or other data in a modulated data signal.

Computer-readable media are any available media that can be accessed within a computing environment 800. By way of example, and not limitation, with the computing environment 800, computer-readable media include memory 820, storage 840, communication media (not shown), and combinations of any of the above.

### Example 18

### Exemplary Automated Methods

Any of the methods described herein can be performed via one or more computer-readable media (e.g., storage media) having computer-executable instructions for performing such methods. Operation can be fully automatic, semi-automatic, or involve manual intervention.

### Example 19

### Exemplary Combinations

The technologies of any example described herein can be combined with the technologies of any one or more other examples described herein.

### Example 20

### Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer implemented method for delivering messages to end-user communication devices for playback to users of the end-user communication devices during call progress events, the method comprising:
selecting one or more messages to be delivered to an end-user communication device; and
delivering the one or more messages to the end-user communication device, wherein the end-user communication device stores the one or more messages, and wherein the end-user communication device plays back the one or more stored messages during call progress events of one or more subsequent calls.

2. The method of claim 1 wherein the one or more messages are selected based on a profile created by a user of the end-user communication device.

3. The method of claim 1 wherein the one or more messages are selected based on interest indicated by a user of the end-user communication device to previously played messages.

4. The method of claim 1 wherein the delivering the one or more messages to the end-user communication device is performed when the end-user communication device is not engaged in a call.

5. The method of claim 1 wherein the delivering the one or more messages to the end-user communication device is performed when the end-user communication device is idle.

6. The method of claim 1 wherein the delivering the one or more messages to the end-user communication device is performed when the end-user communication device is engaged in a call.

7. The method of claim 1 wherein the call progress events are dial tones, ring tones, or ring-back tones.

8. The method of claim 1 further comprising:
receiving, from the end-user communication device, information comprising an indication of which messages of the one or more messages have been played back by the end-user communication device during the call progress events of the one or more subsequent calls.

9. The method of claim 1 further comprising:
receiving, from the end-user communication device, information comprising an indication that the user of the end-user communication device has indicated interest in a message of the one or more messages, wherein the information comprising the indication of interest is received during playback, by the end-user communication device, of the message.

10. The method of claim 9 further comprising:
in response to receiving the information comprising the indication of interest, automatically establishing a connection between the end-user communication device and a provider of the message, wherein the automatically establishing the connection occurs after a current call, during which the message is played, of the end-user communication device has ended.

11. The method of claim 9 further comprising:
in response to receiving the information comprising the indication of interest, automatically sending contact information for the user of the end-user communication device to a provider of the message.

12. The method of claim 1 wherein the one or more messages are one or more advertising messages.

13. The method of claim 1 wherein the end-user communication device is a Voice over Internet Protocol device, and wherein the one or more subsequent calls are Voice over Internet Protocol calls.

14. The method of claim 1 wherein the end-user communication device is an IP-enabled end-user communication device, and wherein the one or more messages are delivered to the IP-enabled end-user communication device over an IP communication network.

15. One or more computer-readable media comprising computer-executable instructions for causing the computing device to perform the method of claim 1.

16. A system for delivering messages to end-user communication devices for playback to users during call progress events, the system comprising:
a message delivery module configured to deliver messages to end-user communication devices of the system, wherein the message delivery module delivers the messages to the end-user communication devices prior to calls where the messages are played, wherein the end-user communication devices store the delivered messages to be played back during subsequent calls, and wherein the stored messages are subsequently played to the users by the end-user communication devices during call progress events of the subsequent calls; and
a reception module configured to receive information comprising indications that the users of the end-user communication devices have indicated interest in messages played back to the users during the subsequent calls.

17. The system of claim 16 wherein the message delivery module delivers the messages to the end-user communication devices during times when the end-user communication devices are not engaged in a call.

18. The system of claim 16 wherein the reception module is configured to receive information from the end-user communication devices comprising identification of which messages of the stored messages have been played back to users during call progress events.

19. The system of claim 16 wherein the message delivery module is configured to deliver message types comprising audio messages, text messages, and video messages.

20. The system of claim 16 further comprising:
a storage module configured to store user profile information for the users of the end-user communication devices, wherein the message delivery module selects the messages to deliver based at least in part on the stored user profile information.

21. The system of claim 16 wherein the system is a Voice over Internet Protocol system.

22. The system of claim 16 wherein the system supports IP communication, wherein the end-user communication devices are IP-enabled end-user communication devices, wherein the message delivery module delivers the messages to the IP-enabled end-user communication devices via an IP communication network, and wherein the reception module receives information from the IP-enabled end-user communication devices via the IP communication network.

23. An end-user communication device for playing back messages to users during call progress events, the end-user communication device comprising:
a communication module configured to receive messages from a communication network, wherein the messages are received when the end-user communication device is not engaged in a call;
a storage module configured to store the received messages; and
a playback module configured to play back stored messages to a user of the end-user communication device during call progress events, wherein the messages are played back during calls initiated after the messages are received and stored.

24. The end-user communication device of claim 23 wherein the communication module is also configured to send information to the communication network, the information comprising indications of user interest in the played back messages.

25. The end-user communication device of claim 23 wherein the communication module is also configured to send information to the communication network, the information comprising indications of which messages have been played back to the user of the end-user communication device during call progress events of the calls.

26. The end-user communication device of claim 23 wherein the end-user communication device is an IP-enabled end-user communication device.

27. A computer implemented method for delivering audio advertising messages to end-user communication devices for playback to users of the end-user communication devices during call progress events, the method comprising:
selecting one or more audio advertising messages to be delivered to an end-user communication device;
delivering the one or more audio advertising messages to the end-user communication device before one or more subsequent calls during which the one or more audio advertising messages are played back;
receiving and storing, by the end-user communication device, the one or more audio advertising messages;
playing back, by the end-user communication device, the one or more stored audio advertising messages to a user of the end-user communication device during call progress events of one or more subsequent calls;
wherein the one or more audio advertising messages are delivered, received, and stored before the one or more subsequent calls during which the one or more audio advertising messages are played back.
